(19) United States
(12) Patent Application Publication
(10) Pub. No.: US 2025/0062522 A1
(43) Pub. Date: Feb. 20, 2025

(54) ANTENNA ASSEMBLY, HOUSING AND MOBILE TERMINAL

(71) Applicants: Yungu (Gu’an) Technology Co., Ltd., Langfang (CN); Hefei Visionox Technology Co., Ltd., Hefei (CN)

(72) Inventors: Huan-Chu HUANG, Taoyuan City (TW); Jie WU, Langfang (CN); Shuang CUI, Langfang (CN)

(73) Assignees: Yungu (Gu’an) Technology Co., Ltd., Langfang (CN); Hefei Visionox Technology Co., Ltd., Hefei (CN)

(21) Appl. No.: 18/937,305

(22) Filed: Nov. 5, 2024

(30) Foreign Application Priority Data
Nov. 17, 2023 (CN) 202311542564.3

(51) Int. Cl. H01Q 1/22; H01Q 21/06

(52) U.S. Cl. CPC H01Q 1/2283; H01Q 21/06

(57) ABSTRACT

An antenna assembly, a housing and a mobile terminal. The mobile terminal includes an antenna assembly and a housing. The antenna assembly includes: a substrate, including a first sub-portion and a second sub-portion that are spaced apart from each other in a first direction; an antenna module, arranged in the first sub-portion and including two or more antenna units spaced apart from one another in the first sub-portion; an integrated circuit, arranged in the second sub-portion; and a plurality of connecting portions, arranged on the substrate and electrically connecting the antenna units with the integrated circuit.

### CROSS REFERENCE

The present disclosure claims priority to Chinese Patent Application No. 202311542564.3 titled “ANTENNA ASSEMBLY, HOUSING AND MOBILE TERMINAL” filed on Nov. 17, 2023, which is incorporated herein by reference in its entirety.

### TECHNICAL FIELD

The present application relates to the technical field of electronic device, and in particular to an antenna assembly, a housing and a mobile terminal.

### BACKGROUND

The functions of wireless communication devices, such as a mobile phone, a smart watch, are constantly evolving, and the requirements of the device appearance and the wireless communication performance by the market are also constantly increasing. To improve the communication performance of a mobile terminal, various antenna modules can be mounted inside the mobile terminal. How to simplify the mounting process of the antenna modules has become an urgent technical problem to be solved.

### SUMMARY

Embodiments of the present application provide an antenna assembly, a housing and a mobile terminal, which can simplify a mounting process of the antenna assembly.

In a first aspect, embodiments of the present application provide an antenna assembly including: a substrate, including a first sub-portion and a second sub-portion that are spaced apart from each other in a first direction; an antenna module, arranged in the first sub-portion and including two or more antenna units spaced apart from one another in the first sub-portion; an integrated circuit, arranged in the second sub-portion; and a plurality of connecting portions, arranged on the substrate, and electrically connecting the antenna units with the integrated circuit.

According to the embodiments of the present application in the first aspect, the substrate further includes a bending portion connecting the first sub-portion with the second sub-portion, and the first sub-portion, the second sub-portion and the bending portion are integrally arranged.

An end of the connecting portion is connected to the antenna units, and another end of the connecting portion extends to the integrated circuit through the bending portion to electrically connect the antenna units with the integrated circuit.

According to any one of the embodiments of the present application in the first aspect, the first sub-portion and the second sub-portion are separately arranged, and the connecting portion includes a first sub-segment arranged in the first sub-portion and electrically connected to the antenna units and a second sub-segment arranged in the second sub-portion and electrically connected to the integrated circuit.

The first sub-segment and the second sub-segment are bound and connected with each other, or the first sub-segment and the second sub-segment are electrically connected with each other through a joint.

According to any one of the embodiments of the present application in the first aspect, the antenna assembly further includes a conductive isolation portion, which is arranged in the first sub-portion and located between two adjacent antenna units.

According to any one of the embodiments of the present application in the first aspect, the conductive isolation portion is arranged on a surface of the first sub-portion, and/or the conductive isolation portion is arranged in the first sub-portion;

According to any one of the embodiments of the present application in the first aspect, the conductive isolation portion includes a first isolation portion arranged on the surface of the first sub-portion and a second isolation portion arranged in the first sub-portion, and the first isolation portion and the second isolation portion are interconnected;

According to any one of the embodiments of the present application in the first aspect, the conductive isolation portion includes a plurality of the first isolation portions arranged on two surfaces of the first sub-portion opposite to each other, respectively, and the second isolation portion is connected to the first isolation portions located on the two surfaces of the first sub-portion opposite to each other.

In a second aspect, embodiments of the present application provide a housing of a mobile terminal, the mobile terminal includes an antenna assembly, the antenna assembly includes a plurality of antenna units, and the housing includes:
a frame, surrounding and forming a hollow space, and including a sub-segment portion.

The sub-segment portion includes an inner surface facing the hollow space and an outer surface away from the hollow space, at least one of the inner surface or the outer surface is recessed to form a first groove, and the first groove extends in an extending direction of the sub-segment portion and is configured to accommodate the plurality of antenna units.

According to the embodiments of the present application in the second aspect, a first bottom wall of the first groove is recessed to form two or more concave cavities, and the concave cavities are configured to correspond to the antenna units, respectively.

According to any one of the embodiments of the present application in the second aspect, the concave cavities and the antenna units are arranged in one-on-one correspondence.

According to any one of the embodiments of the present application in the second aspect, the sub-segment portion includes a passage penetrating through the inner surface and the outer surface, and the passage communicates with the first groove.

According to any one of the embodiments of the present application in the second aspect, the first groove further includes a first side wall connected to a peripheral side of the first bottom wall, and the passage communicates with the first side wall or the first bottom wall; or the sub-segment portion further includes a side surface connecting the inner surface with the outer surface, and the passage is formed by recessing the side surface.

According to any one of the embodiments of the present application in the second aspect, the first groove is located on the outer surface, the housing further includes a second groove formed by recessing the inner surface, and the second groove is configured to accommodate an integrated circuit of the antenna assembly.

In a third aspect, embodiments of the present application provide a mobile terminal, including the antenna assembly according to any one of the embodiments in the first aspect and the housing according to any one of the embodiments in the second aspect, and the first sub-portion is located in the first groove.

According to the embodiments of the present application in the third aspect, the first groove is provided on the outer surface, and the second sub-portion is provided on the inner surface.

According to any one of the embodiments of the present application in the third aspect, the housing further includes a second groove formed by recessing the inner surface, and the second sub-portion is located in the second groove.

According to any one of the embodiments of the present application in the third aspect, the first groove includes a first bottom wall, and the antenna units are arranged on a side of the first sub-portion away from the first bottom wall; and/or, the second groove includes a second bottom wall, and the integrated circuit is arranged on a side of the second sub-portion away from the second bottom wall.

According to any one of the embodiments of the present application in the third aspect, the sub-segment portion includes a passage penetrating through the inner surface and the outer surface, the passage communicates with the first groove, and the connecting portion is electrically connected to the antenna units and the integrated circuit through the passage.

According to any one of the embodiments of the present application in the third aspect, the sub-segment portion further includes a first side surface and a second side surface connecting the inner surface with the outer surface and arranged opposite to each other, the passage is formed by recessing the first side surface, and a top face of the connecting portion away from the second side surface is coplanar with the first side surface, or a top face of the connecting portion away from the second side surface is located on a side of the first side surface facing the second side surface.

According to any one of the embodiments of the present application in the third aspect, the antenna assembly further includes a connector, the connector is electrically connected to the integrated circuit, and each of the connector and the integrated circuit is arranged in the second sub-portion.

According to any one of the embodiments of the present application in the third aspect, the plurality of antenna units are spaced apart from one another in the extending direction of the sub-segment portion; and/or the integrated circuit and the connector are spaced apart from each other in the extending direction of the sub-segment portion.

According to any one of the embodiments of the present application in the third aspect, the housing further includes a decorative cover, which is arranged in the first groove and/or the second groove.

According to any one of the embodiments of the present application in the third aspect, two or more concave cavities are formed by recessing a first bottom wall of the first groove, and projections of the antenna units in a thickness direction of the sub-segment portion at least partially overlap with projections of the concave cavities in the thickness direction.

According to any one of the embodiments of the present application in the third aspect, the projections of the antenna units in the thickness direction are located within the projections of the concave cavities in the thickness direction.

### BRIEF DESCRIPTION OF THE DRAWINGS

Other features, objectives and advantages of the present application will become more apparent by reading the detailed description of non-limiting embodiments with reference to the drawings, and the same or similar reference numerals represent the same or similar features.

FIG. 1 is a structural schematic view of an antenna assembly according to an embodiment of the present application;

FIG. 2 is a structural schematic view of an antenna assembly according to an embodiment of the present application in another perspective;

FIG. 3 is a structural schematic view of an antenna assembly according to another embodiment of the present application;

FIG. 4 is a structural schematic view of an antenna assembly according to another embodiment of the present application in another perspective;

FIG. 5 is a structural schematic view of an antenna assembly according to another embodiment of the present application;

FIG. 6 is a structural schematic view of an antenna assembly according to another embodiment of the present application in another perspective;

FIG. 7 is a structural schematic view of an antenna assembly according to another embodiment of the present application;

FIG. 8 is a structural schematic view of a housing according to an embodiment of the present application;

FIG. 9 is a structural schematic view of a sub-segment portion of a housing according to an embodiment of the present application;

FIG. 10 is a structural schematic view of a sub-segment portion of a housing provided with an antenna assembly according to an embodiment of the present application;

FIG. 11 is a structural schematic view of the housing in FIG. 10 in another perspective;

FIG. 12 is a structural schematic view of a sub-segment portion of a housing according to another embodiment of the present application;

FIG. 13 is a structural schematic view of the sub-segment portion of the housing in FIG. 12 in another perspective;

FIG. 14 is a structural schematic view of a sub-segment portion of a housing provided with an antenna assembly according to another embodiment of the present application;

FIG. 15 is a structural schematic view of a sub-segment portion of a housing according to another embodiment of the present application;

FIG. 16 is a structural schematic view of the sub-segment portion of the housing in FIG. 15 in another perspective;

FIG. 17 is a structural schematic view of a sub-segment portion of a housing provided with an antenna assembly according to another embodiment of the present application;

FIG. 18 is a structural schematic view of the housing in FIG. 17 in another perspective;

FIG. 19 is a structural schematic view of a sub-segment portion of a housing provided with an antenna assembly according to another embodiment of the present application;

FIG. 20 is a structural schematic view of the housing in FIG. 19 in another perspective; and

FIG. 21 is a front view of the housing in FIG. 19.

### REFERENCE NUMERALS

10. antenna assembly; 20. housing;
100. substrate; 110. first sub-portion; 120. second sub-portion; 130. bending portion; 140. conductive isolation portion; 141. first conductive isolation portion; 142. second conductive isolation portion;
200. antenna module; 210. antenna unit;
300. integrated circuit;
400. connecting portion; 410. first sub-segment; 420. second sub-segment;
500. frame; 501. sub-segment portion; 502. hollow space; 510. inner surface; 520. outer surface;
530. first groove; 531. first bottom wall; 532. first side wall; 533. concave cavity; 540. passage;
550. side surface; 551. first side surface; 552. second side surface; 560. second groove;
600, connector;
700. decorative cover;
Y. first direction; X. second direction; Z. third direction.

### DETAILED DESCRIPTION

Features and exemplary embodiments in various aspects of the present application will be described in detailed below. In the following detailed description, many specific details are presented to provide a comprehensive understanding of the present application. However, it is apparent to those skilled in the art that the present application can be implemented without requiring some of these specific details. The following description of the embodiments is merely intended to provide a better understanding of the present application by illustrating examples of the present application. At least some of the well-known structures and techniques are not shown in the drawings and the following description to avoid the unnecessary ambiguity in the present application. In addition, in order to clarity, the sizes of some structures may have been exaggerated. Moreover, the features, structures or characteristics described below may be combined in one or more embodiments in any suitable manner.

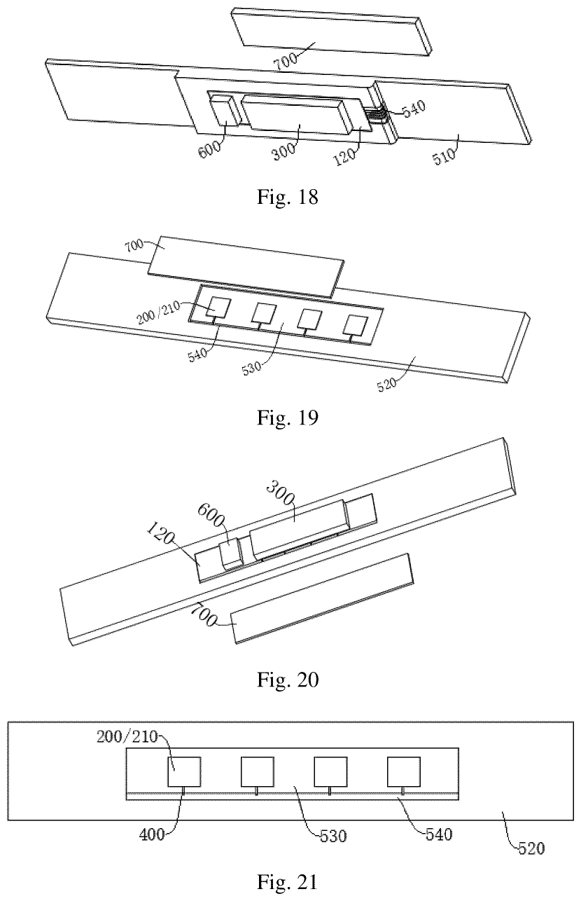

In order to better understand the present application, an antenna assembly 10, a housing 20 and a mobile terminal according to embodiments of the present application will be described in detail below with reference to FIG. 1 to FIG. 21.

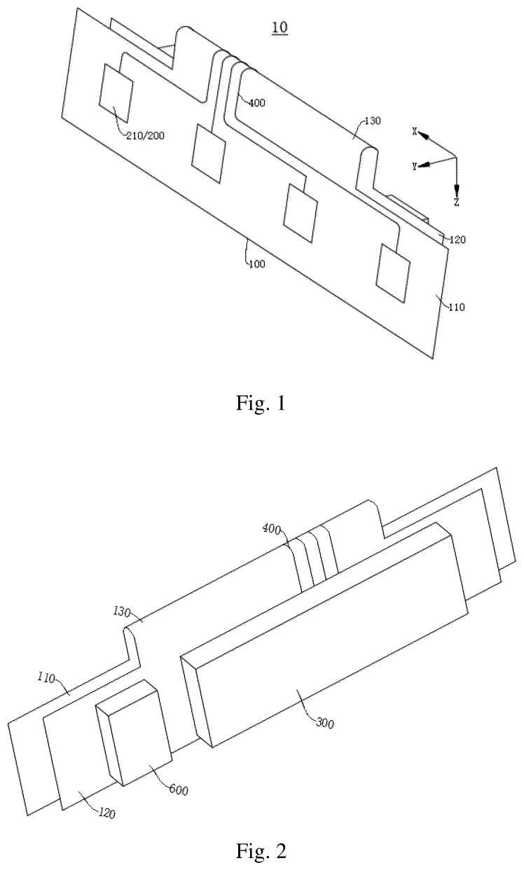

Referring to FIG. 1 to FIG. 2, FIG. 1 is a structural schematic view of an antenna assembly 10 according to an embodiment of the present application; FIG. 2 is a structural schematic view of an antenna assembly 10 according to an embodiment of the present application in another perspective.

As shown in FIG. 1 and FIG. 2, in a first aspect, embodiments of the present application provide an antenna assembly 10, including a substrate 100, an antenna module 200, an integrated circuit 300 and a plurality of connecting portions 400. The substrate 100 includes first sub-portion 110 and a second sub-portion 120 in a first direction Y. The antenna module 200 is arranged in the first sub-portion 110 and includes two or more antenna units 210 spaced apart from one another in the first sub-portion 110. The integrated circuit 300 is arranged in the second sub-portion 120. The connecting portion 400 is arranged on the substrate 100 and electrically connects the antenna units 210 with the integrated circuit 300.

In the antenna assembly 10 provided in the present application, the antenna assembly 10 includes the substrate 100, the antenna module 200, the integrated circuit 300 and the connecting portion 400. The substrate 100 provides arranging positions for the antenna module 200, the integrated circuit 300 and the connecting portion 400. The plurality of antenna units 210 are spaced apart from one another in the first sub-portion 110, and the integrated circuit 300 is arranged in the second sub-portion 120, which can reduce the position interference between the antenna units 210 and the integrated circuit 300. The antenna units 210 located at different positions on the substrate 100 and the integrated circuit 300 are electrically connected to each other through connecting portion 400, so that the integrated circuit 300 to send control signals to the antenna units 210. In the antenna assembly 10 of the present application, each of the antenna module 200, the integrated circuit 300 and the connecting portion 400 is arranged on the substrate 100, and then the substrate 100 with the antenna module 200, the integrated circuit 300 and the connecting portion 400 is arranged at a target position. For example, when the antenna assembly 10 is used in the mobile terminal, it is convenient to uniformly place the substrate 100 with the antenna module 200, the integrated circuit 300 and connecting portion 400 on the housing 20 of the mobile terminal, which can simplify the mounting process of the antenna assembly 10 and reduce the related cost.

Optionally, the first sub-portion 110 and the second sub-portion 120 can be distributed at intervals in the first direction Y. Optionally, the integrated circuit 300 may include a radio frequency integrated circuit and a battery management integrated circuit. The radio frequency integrated circuit is connected to the antenna units 210 to transmit radio frequency signals to the antenna units 210. Optionally, the integrated circuit 300 may include only the radio frequency integrated circuit.

In some optional embodiments, referring to FIG. 1 to FIG. 4, the substrate 100 further includes a bending portion 130 connecting the first sub-portion 110 with the second sub-portion 120, and the first sub-portion 110, the second sub-portion 120 and the bending portion 130 are integrally arranged. An end of the connecting portion 400 is connected to the antenna units 210, and another end of the connecting portion extends to the integrated circuit 300 through the bending portion 130 to electrically connect the antenna units 210 with the integrated circuit 300.

In these optional embodiments, the substrate 100 is integrally arranged in a general U-shape and includes the first sub-portion 110, the second sub-portion 120 and the bending portion 130, so that the antenna assembly 10 can break through a metal shielding through the substrate 100. For example, the antenna assembly 10 can be arranged on a frame of the mobile terminal, and the substrate 100 can cover an inner surface and an outer surface of the frame to break through the metal shielding. Therefore, it can ensure that a distance between the antenna units 210 and the integrated circuit 300 is closer, the loss between the two can be reduced, the performance of the antenna assembly 10 can be improved, and the quality of the wireless communication can be improved. There are various ways to arrange the substrate 100, such as a rigid substrate 100, a glass structure, a steel plate or other structures. Alternatively, the material of the substrate 100 may include a flexible material such as polyimide, liquid crystal polymer, polyethylene terephthalate (PET) or cycloolefin polymer (COP), which can facilitate changing the shape of the substrate 100 according to the mounting position and further simplify the mounting difficulty of the antenna assembly 10.

Optionally, the antenna assembly 10 further includes a connector 600, which is electrically connected to the integrated circuit 300. Each of the connector 600 and the integrated circuit 300 is arranged in the second sub-portion 120, so as to reduce a distance between the connector 600 and the integrated circuit 300, facilitate the connection between the connector 600 and the integrated circuit 300. The integrated circuit 300 can be electrically connected to an outer side through the connector 600, for example, the integrated circuit 300 can be electrically connected to a motherboard of the mobile terminal through the connector 600.

When the material of the substrate 100 includes the flexible material, the integrated circuit 300, the connecting portion 400, the antenna units 210 and the connector 600 can also be arranged on the substrate 100 in a planar state, thereby facilitating the arrangement of the integrated circuit 300, the connecting portion 400, the antenna units 210 and the connector 600; then, the substrate 100 is bent to form the first sub-portion 110 and the second sub-portion 120 spaced apart from each other in the first direction Y and the bending portion 130 connecting the first sub-portion 110 with the second sub-portion 120, thereby facilitating arranging the substrate 100 at the target position through a U-shaped opening.

Optionally, a width and a length of the first sub-portion 110 and a width and a length of the second sub-portion 120 may be respectively the same or different. To simplify the shape of the substrate 100, the width and the length of the first sub-portion 110 and the width and the length of the second sub-portion 120 may be the same. The width of the first sub-portion 110 and the width of the second sub-portion 120 are sizes of the first sub-portion 110 and the second sub-portion 120 extending in a third direction Z, respectively, and the length of the first sub-portion 110 and the length of second sub-portion 120 are sizes of the first sub-portion 110 and the second sub-portion 120 extending in the second direction Y, respectively. Optionally, a length of the bending portion 130 may be the same as or different from the length of the first sub-portion 110 and the length of the second sub-portion 120. For example, based on the limitation of the target position, the length of the bending portion 130 may be smaller than the length of the first sub-portion 110 and the length of the second sub-portion 120.

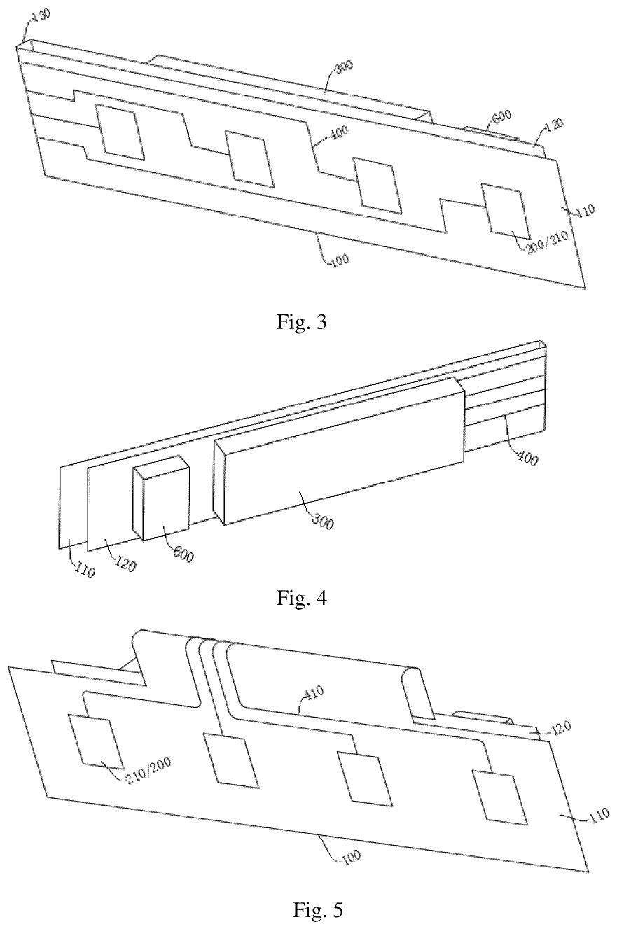

As shown in FIG. 1 and FIG. 2, there are various ways to arrange the bending portion 130. The bending portion 130 can be connected to a side of the first sub-portion 110 in the third direction Z. Alternatively, as shown in FIG. 3 and FIG. 4, the bending portion 130 can be connected to a side of the first sub-portion 110 in the second direction X. Optionally, the size of the first sub-portion 110 extending in its second direction X is larger than the size of the first sub-portion 110 extending in the third direction Z.

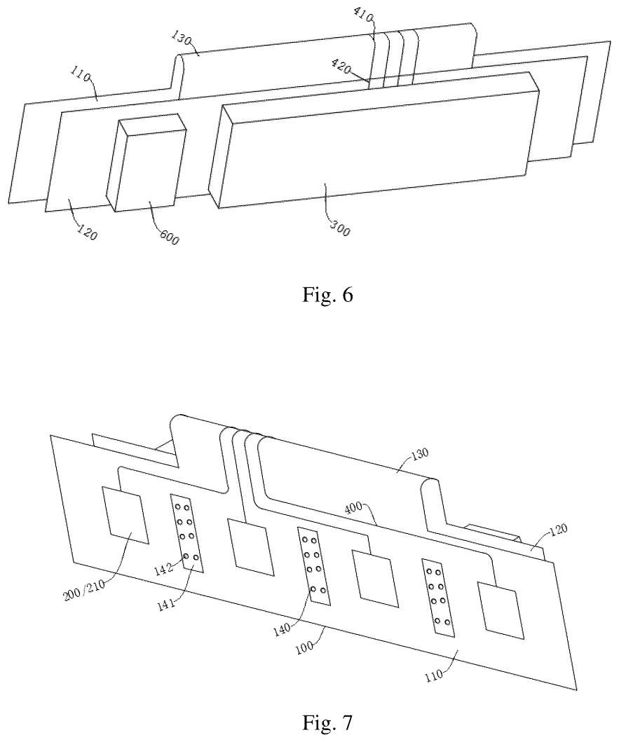

In other optional embodiments, as shown in FIG. 5 and FIG. 6, the first sub-portion 110 and the second sub-portion 120 are separately arranged, and the connecting portion 400 includes a first sub-segment 410 arranged in the first sub-portion 110 and electrically connected to the antenna units 210, and a second sub-segment 420 arranged in the second sub-portion 120 and electrically connected to the integrated circuit 300. The first sub-segment 410 and the second sub-segment 420 are bound and connected to each other, or the first sub-segment 410 and the second sub-segment 420 are electrically connected to each other through a joint. In these optional embodiments, the first sub-portion 110 and the second sub-portion 120 are separately arranged. In this case, the antenna units 210 and the integrated circuit 300 can be respectively arranged on two different portions of the substrate 100. The antenna units 210 are arranged on the substrate 100, the integrated circuit 300 is arranged on the substrate 100, and the antenna units 210 and the integrated circuit 300 do not interfere with each other. The connecting portion 400 is divided into the first sub-segment 410 and the second sub-segment 420. The first sub-segment 410 and the second sub-segment 420 can be bound and connected to each other, which can increase the freedom of material selection, reduce the size of the antenna module 200, lower the cost, and improve the reliability of the performance of the antenna module 200. Alternatively, the first sub-segment 410 and the second sub-segment 420 can be connected to each other through a plug for easy maintenance and replacement.

Optionally, as shown in FIG. 5 and FIG. 6, the bending portion 130 and the first sub-portion 110 can be integrally arranged, and the bending portion 130 and the second sub-portion 120 can be separately arranged and connected to each other. In other embodiments, the bending portion 130 and the second sub-portion 120 can be integrally arranged, and the bending portion 130 and the first sub-portion 110 can be separately arranged and connected to each other.

In some optional embodiments, as shown in FIG. 7, the antenna assembly 10 further includes a conductive isolation portion 140, which is arranged in the first sub-portion 110 and located between two adjacent antenna units 210.

In these optional embodiments, the conductive isolation portion 140 is arranged between two adjacent antenna units 210, which can solve the problem of the signal interference between the two adjacent antenna units 210.

Optionally, the conductive isolation portion 140 can be arranged on a surface of the first sub-portion 110, and/or the conductive isolation portion 140 can be arranged in the first sub-portion 110, as long as the conductive isolation portion 140 is located between two adjacent antenna units 210.

Optionally, the conductive isolation portion 140 includes a first isolation portion 141 arranged on the surface of the first sub-portion 110 and a second isolation portion 142 arranged in the first sub-portion 110. The first isolation portion 141 and the second isolation portion 142 are connected to each other. By arranging the first isolation portion 141 located on the surface of the first sub-portion 110 and the second isolation portion 142 located in the first sub-portion 110, the isolation between two adjacent antenna units 210 can be increase in the first direction Y, so as to solve the problem of the antenna coupling between two adjacent antenna units 210, and improve the performance of the wireless communication.

Optionally, each of the surfaces of the first sub-portion 110 facing and away from the second sub-portion 120 is provided with the first conductive isolation portion 141, that is, the conductive isolation portion includes a plurality of the first isolation portions 141 arranged on two surfaces the first sub-portion 110 opposite to each other, and the second isolation portion 142 is connected to the first isolation portions 141 located on the two surfaces of the first sub-portion 110 opposite to each other, thereby further increasing the isolation between two adjacent antenna units 210, further solving the problem of the antenna coupling between two adjacent antenna units 210, and improving the performance of the wireless communication.

Optionally, when the antenna assembly 200 is arranged on the housing of the mobile terminal, the first conductive isolation portion 141 on the surface of the first sub-portion 110 facing the second sub-portion 120 can be in contact with and connected to the frame of the housing, so as to better solve the problem of the antenna coupling between two adjacent antenna units 210, and improve the performance of the wireless communication. In any one of the embodiments as described above, there are various ways to arrange the antenna module 200. The antenna module 200 can be used to transmit and receive the wireless signals in various frequency bands, for example, the wireless module is used to transmit and receive the millimeter wave wireless signals.

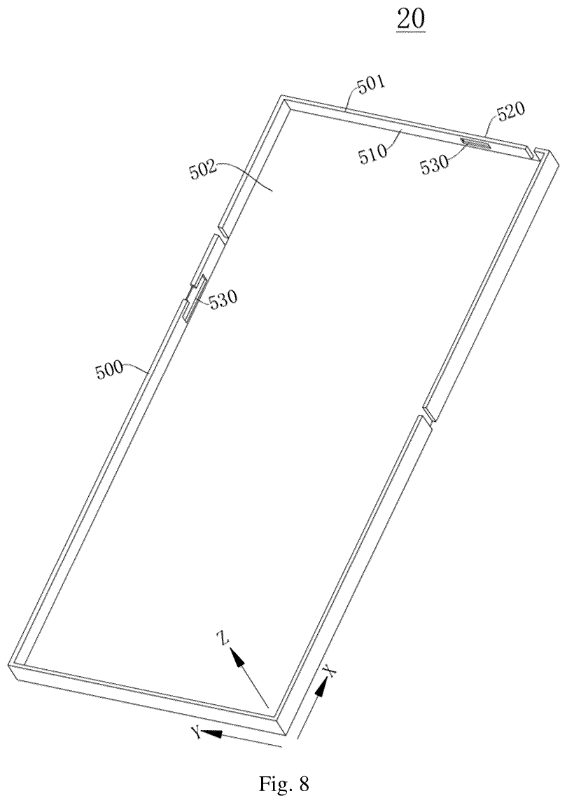

Referring to FIG. 8 to FIG. 11, in a second aspect, embodiments of the present application provides a housing 20 of a mobile terminal. The mobile terminal includes an antenna assembly 10, which includes a plurality of antenna units 210. Optionally, the antenna assembly 10 may be the antenna assembly 10 according to any one of the embodiments as described above, or the antenna assembly 10 may be the antenna assembly 10 in other embodiments. The present application takes the antenna assembly 10 provided by any one of the embodiments as described in the first aspect as an example to illustrate.

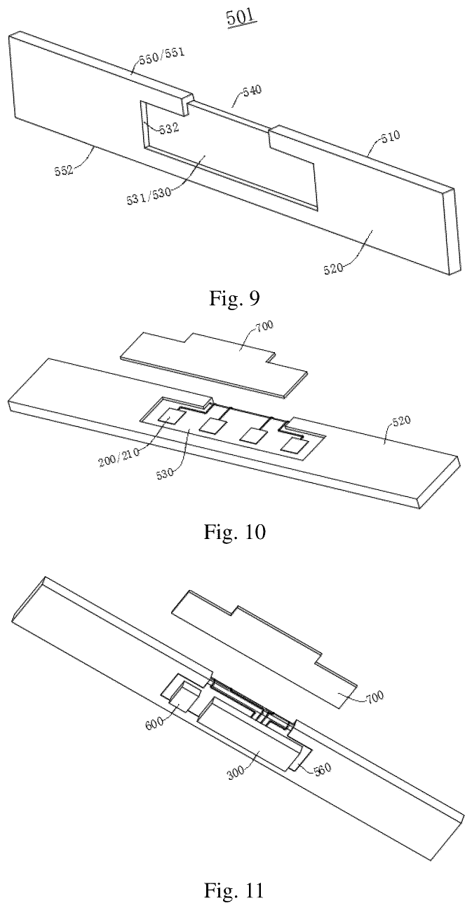

There are various ways to arrange the housing 20. In some embodiments, as shown in FIG. 8 to FIG. 10, FIG. 8 shows a structural schematic view of a frame 500; FIG. 9 shows a structural schematic view of a sub-segment portion 501; and FIG. 10 and FIG. 11 show structural schematic views of a sub-segment portion from different perspectives when the antenna assembly 10 is arranged in the sub-segment portion 501. The housing 20 includes the frame 500, which surrounds and form a hollow space 502. The frame 500 includes the sub-segment portion 501, which includes an inner surface 510 facing the hollow space 502 and an outer surface 520 away from the hollow space 502. At least one of the inner surface 510 and the outer surface 520 is recessed to form a first groove 530, which extends in an extending direction of the sub-segment portion 501 and is used to accommodate the plurality of antenna units 210.

In these optional embodiments, a portion of the sub-segment portion 501 of the frame 500 is recessed to form the first groove 530, which can accommodate the plurality of antenna units 210. For example, when the antenna assembly 10 is the above-mentioned antenna assembly 10, the first groove 530 can accommodate the substrate 100, and the antenna units 210 are arranged on the substrate 100 and spaced apart from one another. The plurality of antenna units 210 are accommodated in the same first groove 530, which can improve the mounting process of the plurality of antenna units 210, improve the assembly efficiency of the antenna assembly 10, and reduce the costs.

Optionally, the frame 500 may be provided with a plurality of first grooves 530, each of which is used to accommodate the plurality of antenna units. The plurality of first grooves 530 are arranged at different positions of the frame 500, so that a plurality of antenna assemblies 200 cannot be covered simultaneously when the mobile terminal is in various states such as a landscape state or a portrait state, the blind spots of the wireless signals can be reduced and the communication quality can be better. The extending direction of the sub-segment portion 501 may be the extending direction of the sub-segment portion 501 surrounding the hollow space 502. For example, the frame 500 includes the plurality of sub-segment portions 501, which are connected in the form of beginning-to-end to surround and form the hollow space 502. The plurality of sub-segment portions 501 include two first sub-sub-segment portions distributed at intervals in the first direction Y and two second sub-sub-segment portions distributed at intervals in the second direction Y. The two first sub-sub-segment portions and the two second sub-sub-segment portions are alternately arranged to enclose and form a hollow portion. When the first groove 530 is provided in the first sub-segment, an extending direction of the first sub-segment is the second direction X, and the first groove 530 extends in the second direction X. The plurality of antenna units 210 can be distributed at intervals in the second direction X in the first groove 530. When the first groove 530 is provided in the second sub-segment, an extending direction of the second sub-segment is the first direction Y, the first groove 530 extends in the first direction Y, and the plurality of antenna units 210 can be distributed at intervals in the first direction Y in the first groove 530.

Optionally, the frame can be a middle frame of the mobile terminal.

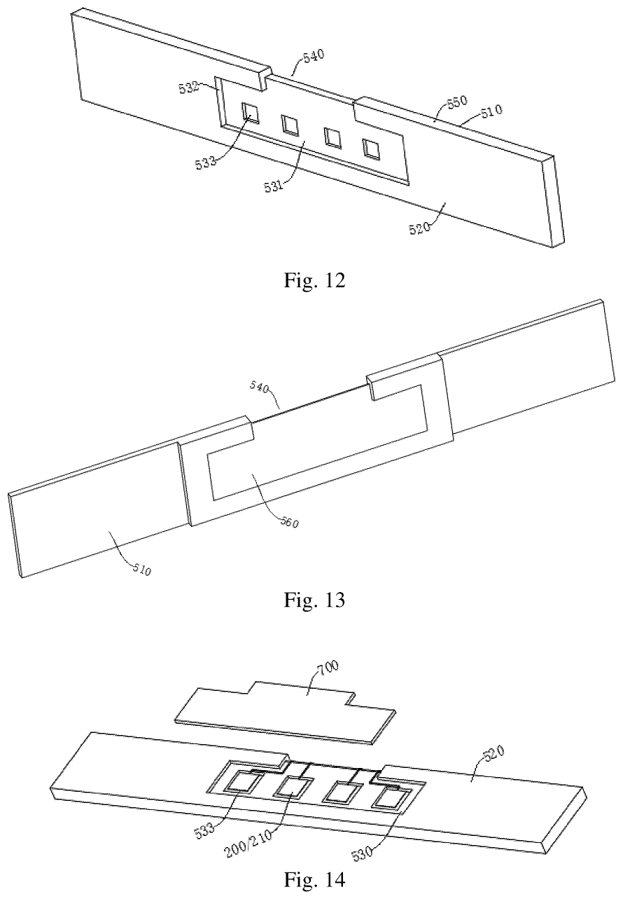

In some optional embodiments, as shown in FIG. 12 to FIG. 14, FIG. 12 and FIG. 13 show structural schematic views of the sub-segment portion 501 from different perspectives, and FIG. 14 shows a structural schematic view of the antenna assembly 10 arranged in the sub-segment portion 501 shown in FIG. 12 and FIG. 13 from different perspectives. A first bottom wall 531 of the first groove 530 is recessed to form two or more concave cavities 533, and the concave cavities 533 are used to correspond to the antenna units 210, respectively.

In these optional embodiments, the first bottom wall 531 of the first groove 530 is provided with the concave cavities 533. When the antenna units 210 are arranged in the first groove 530, a position of the antenna units 210 corresponds to positions of the concave cavities 533, that is, orthographic projections of the antenna units 210 on the first bottom wall 531 at least partially overlaps with the concave cavities 533, so that a distance between the antenna units 210 and surfaces of the concave cavities 533 can increase, the problem of affecting the antenna performance due to the close distance between the first bottom wall 531 and the antenna units 210 can be solved, the antenna performance can be better and the wireless communication quality can be better.

Optionally, the concave cavities 533 and the antenna units 210 are arranged in one-on-one correspondence, so that each of the antenna units 210 corresponds to one concave cavity 533.

Optionally, the size of the concave cavities 533 is smaller than the size of the first groove 530. For example, a projection of the concave cavities 533 in the thickness direction Z of the sub-segment portion 501 is located within a projection of the first groove 530 in the thickness direction Z of the sub-segment portion 501, so that at least a portion of the first wall protrudes from the concave cavities 533. For example, the first bottom wall 531 on a peripheral side of the concave cavities 533 protrudes from the concave cavities 533, so that the antenna units 210 or the substrate 100 used to arrange the antenna units 210 can be connected to the peripheral side of the concave cavities 533, so as to ensure the distance between the antenna units 210 and the surfaces of the concave cavities 533.

Optionally, as shown in FIG. 13, in order to provide the concave cavities 533 and the first groove 530 on the sub-segment portion 501, a thickness of a portion of the sub-segment portion 501 can increase. For example, the thickness of the portion of the sub-segment portion 501 used to provide the first groove 530 and the concave cavities 533 can increase, so as to improve the structural strength of the sub-segment portion 501.

In some optional embodiments, the sub-segment portion 501 includes a passage 540 penetrating through the inner surface 510 and the outer surface 520, and the passage 540 communicates with the first groove 530.

In these optional embodiments, the sub-segment portion 501 further includes the passage 540, which communicates with the first groove 530, so that the connecting portion 400 can be connected to the antenna units 210 located in the first groove 530 through the passage 540, and the antenna units 210 can be electrically connected to the integrated circuit 300.

There are various positions for arranging the passage 540, for example, as shown in FIG. 8 to FIG. 14, the sub-segment portion 501 further includes a side surface 550 connecting the inner surface 510 with the outer surface 520, and the passage 540 can be formed by recessing the side surface 550. When the substrate 100 includes the first sub-portion 110, the second sub-portion 120 and the bending portion 130, the bending portion 130 can be located in the passage 540, so as to solve the problem of the bending portion 130 protruding from the side surface 550 too high.

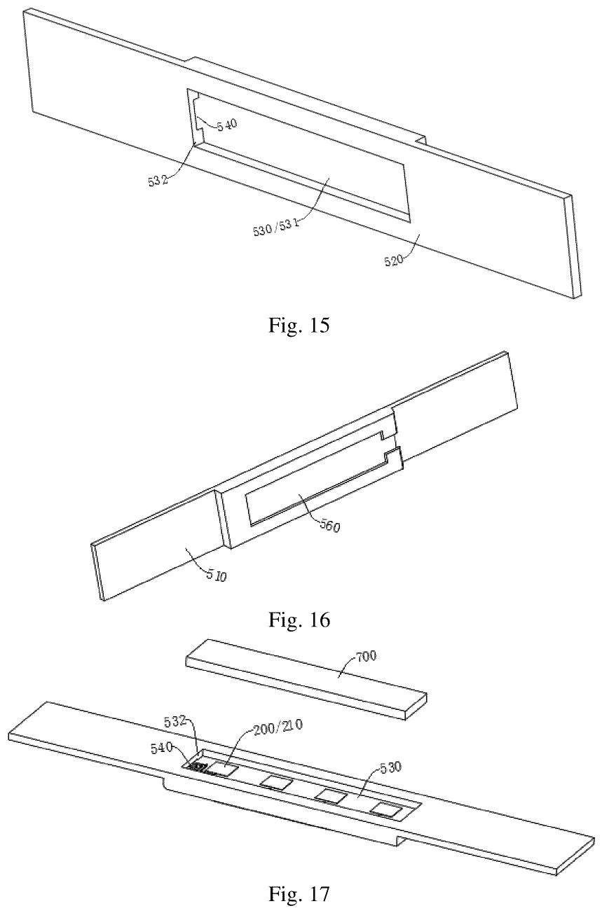

In other embodiments, as shown in FIG. 15 to FIG. 18, the first groove 530 further includes a first side wall 532 connected to a peripheral side of the first bottom wall 531, and the passage 540 communicates with the first side wall 532. Alternatively, as shown in FIG. 19 to FIG. 21, the passage 540 communicates with the first bottom wall 531. When the substrate 100 includes the first sub-portion 110 and the second sub-portion 120 that are separately arranged, the first sub-portion 110 and the second sub-portion 120 can be arranged on the inner surface 510 and the outer surface 520, respectively, and the connecting portion 400 is connected to the antenna units 210 and the integrated circuit 300 through the passage 540 that communicates the first side wall 532 with the first bottom wall 531.

The first groove 530 can be provided on the inner surface 510 or the outer surface 520.

In some optional embodiments, the first groove 530 is located on the outer surface 520, the housing 20 further includes a second groove 560 formed by recessing the inner surface 510, and the second groove 560 is used to accommodate the integrated circuit 300 of the antenna assembly 10.

In these optional embodiments, the first groove 530 is located on the outer surface 520, so that the antenna units 210 arranged in the first groove 530 can be exposed, so as to reduce the influence of the frame 500 on the signal transmission of the antenna units 210. The inner surface 510 is also provided with the second groove 560, the second groove 560 accommodates the integrated circuit 300, and the second groove 560 can provide positioning and limiting to the second sub-portion 120 used for arranging the integrated circuit 300.

Optionally, the housing 20 may further include a decorative cover 700, which can cover the first groove 530. The decorative cover 700 can achieve the effects such as aesthetic, wear-resistant, waterproof, dustproof and anti drop.

Optionally, a material of the frame 500 may include a metallic material to achieve the sufficient structural strength. Optionally, a material of the decorative cover 700 may include an insulating material to improve the signal transmission of the antenna units 210 inside the first groove 530 when the decorative cover 700 covers the first groove 530.

Optionally, a shape of the decorative cover 700 matches with a shape of the first groove 530. The area and the shape of the decorative cover 700 are the same as the area and the shape of the first bottom wall 531, and the decorative cover 700 is in contact with and connected to the first side wall 532. Optionally, when the first groove 530 is provided on the outer surface 520, the decorative cover 700 is flush with the outer surface 520, so as to ensure the flatness of the outer surface 520 of the frame 500. When the first groove 530 is provided on the inner surface 510, the decorative cover 700 can also be flush with the inner surface 510.

As described above, when the passage 540 communicates with the first side wall 532 or the first bottom wall 531, the decorative cover 700 may not be irregular, so it is friendly to the aesthetic design of the appearance and the aesthetics of the most consumers.

Optionally, the decorative cover 700 covers the second groove 560, and the shape of the decorative cover 700 matches with the shape of the second groove 560. The second groove 560 includes a second bottom wall and a second side wall connected to a peripheral side of the second bottom wall. The area and the shape of the decorative cover 700 are the same as the area and the shape of the second bottom wall, and the decorative cover 700 is in contact with and connected to the second side wall. Optionally, when the second groove 560 is provided on the inner surface 510, the decorative cover 700 is flush with the inner surface 510 to ensure the flatness of the inner surface 510 of the frame 500. When the second groove 560 is provided on the outer surface 520, the decorative cover 700 is flush with the outer surface 520.

In any one of the above embodiments, when the antenna assembly 10 includes the conductive isolation portion 140, a projection of the conductive isolation portion 140 in the first direction Y are misaligned with projections of the concave cavities 533 in the first direction Y. For example, the projection of the conductive isolation portion 140 in the first direction Y is located between the projections of two adjacent concave cavities 533 in the first direction Y. Optionally, when a conductive isolation portion 140 is arranged on a side of the first sub-portion 110 facing the second sub-portion 120, the conductive isolation portion 140 located on the side of the first sub-portion 110 facing the second sub-portion 120 can be electrically connected to the sub-segment portion 501, so as to further increase the isolation between two adjacent antenna units 210, and achieve the better antenna performance and the better quality of the wireless communication.

As shown in FIG. 1 to FIG. 20, in a third aspect, embodiments of the present application further provide a mobile terminal, including the antenna assembly 10 according to any one of the embodiments in the first aspect and the housing 20 according to any one of the embodiments in the second aspect, and the first sub-portion 110 of the substrate 100 is located in the first groove 530.

The mobile terminals in the embodiments of the present application include but are not limited to the devices with the display functions such as a mobile phone, a personal digital assistant (PDA), a tablet, an e-book, a television, an access control system, a smart landline phone and a console.

In the mobile terminal provided by this embodiment, the first groove 530 is formed by recessing a portion of the sub-segment portion 501 of the frame 500. The first groove 530 can accommodate the first sub-portion 110 of the substrate 100, and the plurality of antenna units 210 spaced apart from one another are arranged in the first sub-portion 110. The plurality of antenna units 210 are accommodated in the same first groove 530, which can improve the mounting process of the plurality of antenna units 210, and improve the assembly efficiency of the antenna assembly 10.

In some optional embodiments, the first groove 530 is provided on the outer surface 520, and the second sub-portion 120 is provided on the inner surface 510.

In these optional embodiments, the first groove 530 is located on the outer surface 520, and the first sub-portion 110 arranged in the first groove 530 is located on the outer surface 520, so that the plurality of antenna units 210 located in the first sub-portion 110 can be located on the outer surface 520, the shielding of the antenna units 210 by the housing 20 can be improved, the antenna units 210 can be exposed, and the performance of the antenna assembly 10 can be improved. The second sub-portion 120 is located on the inner surface 510, so that the integrated circuit 300 located on the second sub-portion 120 is located on the inner surface 510, and the frame 500 can protect the integrated circuit 300.

In some optional embodiments, the frame 500 further includes the second groove 560 formed by recessing the inner surface 510, and the second sub-portion 120 is located in the second groove 560, so that the second groove 560 can provide the positioning and limiting to the second sub-portion 120.

Optionally, the first groove 530 includes the first bottom wall 531, and the antenna units 210 are arranged on a side of the first sub-portion 110 away from the first bottom wall 531, so as to improve the shielding of the antenna units 210 by the first sub-portion 110.

Optionally, the second groove 560 includes the second bottom wall, and the integrated circuit 300 is arranged on a side of the second sub-portion 120 away from the second bottom wall, so that the integrated circuit 300 are exposed, thereby facilitating the connection between the antenna units 210 and the integrated circuit 300 through the connecting portion 400.

Optionally, as described above, the sub-segment portion 501 includes the passage 540 penetrating through the inner surface 510 and the outer surface 520, the passage 540 communicates with the first groove 530, and the connecting portion 400 is electrically connected to the antenna units 210 and the integrated circuit 300 through the passage 540. By arranging the passage 540 on the frame 500, the connecting portion 400 can be electrically connected to the antenna units 210 and the integrated circuit 300 through the passage 540, so as to shorten an extending length of the connecting portion 400.

Optionally, the sub-segment portion 501 further includes a first side surface 551 and a second side surface 552 connecting the inner surface 510 with the outer surface 520 and arranged opposite to each other, the passage 540 is formed by recessing the first side surface 551, that is, the passage 540 is formed by reducing a local size of the sub-segment portion 501. When the substrate 100 is in U-shaped and includes the first sub-portion 110, the second sub-portion 120 and the bending portion 130 connecting the first sub-portion 110 with the second sub-portion 120, the bending portion 130 can be located in the passage 540, so as to solve the problem of affecting the flatness of the overall surface of the frame due to the excessive size of a portion of the bending portion 130 protruding from the sub-segment portion 501.

For example, a top face of the connecting portion 400 away from the second side surface 552 is coplanar with the first side surface 551, or a top face of the connecting portion 400 away from the second side surface 552 is located on a side of the first side surface 551 facing the second side surface 552, so that the connecting portion 400 cannot protrude from the position of the first side surface 551 except for the passage 540, the flatness of the overall surface of the frame can be improved.

Optionally, antenna assembly 10 further includes a connector 600, which is electrically connected to the integrated circuit 300. Both the connector 600 and the integrated circuit 300 are arranged in the second sub-portion 120, so as to reduce the distance between the connector 600 and the integrated circuit 300, facilitate the connection between the connector 600 and the integrated circuit 300. The integrated circuit 300 can be electrically connected to the outer side through the connector 600, for example, the integrated circuit 300 can be electrically connected to the motherboard of the mobile terminal through the connector 600.

Optionally, the plurality of antenna units 210 are distributed at intervals in the extending direction of the sub-segment portion 501, so that more antenna units 210 can be arranged on the sub-segment portion 501. The extending direction of the sub-segment portion 501 is as described above and will not be repeated here.

Optionally, the integrated circuit 300 and the connector 600 are distributed at intervals in the extending direction of the sub-segment portion 501. The size of the sub-segment portion 501 in its own extending direction is relatively large, so as to provide more space for the integrated circuit 300 and the connector 600 to be arranged.

Optionally, as described above, the housing 20 may further include the decorative cover 700, which can cover the first groove 530 and/or the second groove 560. The arrangement of the decorative cover 700 is as described above, and will not be repeated here.

In some optional embodiments, two or more concave cavities 533 are formed by recessing the first bottom wall 531 of the first groove 530, and projections of the antenna units 210 in a thickness direction of the sub-segment portion 501 at least partially overlap with projections of the concave cavities 533 in the thickness direction. There are various thickness directions of the sub-segment portion 501; for example, when the sub-segment portion 501 is the first sub-segment 410 as described above, the thickness direction is the first direction Y; alternatively, when the sub-segment portion 501 is the second sub-segment 420 as described above, the thickness direction is the second direction X. The thickness direction of the sub-segment portion 501 can be considered as a direction in which the inner surface 510 and outer surface 520 of the sub-segment portion 501 are spaced apart from each other.

In these optional embodiments, the first bottom wall 531 of the first groove 530 is provided with the concave cavities 533, and the projections of the concave cavities 533 at least partially overlap with the projections of the antenna units 210, which can increase the distance between the antenna units 210 and at least a portion of the first bottom wall 531, solve the problem of affecting the operation of the antenna units 210 due to the too short distance between the first bottom wall 531 and the antenna units 210, and improve the performance of the antenna assembly 10.

Optionally, the projections of the antenna units 210 in the thickness direction of the sub-segment portion 501 are located within the projections of the concave cavities 533 in the thickness direction of the sub-segment portion 501, so as to better improve the performance of the antenna assembly 10.

Although the present disclosure has been described with reference to the preferred embodiments, various modifications may be made to the present disclosure and components may be replaced with equivalents without departing from the scope of the present disclosure. In particular, the technical features mentioned in the various embodiments can be combined in any manner as long as there is no structural conflict. The present disclosure is not limited to the specific embodiments disclosed herein, but includes all technical solutions falling within the scope of the claims.

What is claimed is:

1. An antenna assembly, comprising:
a substrate, comprising a first sub-portion and a second sub-portion;
an antenna module, arranged in the first sub-portion and comprising two or more antenna units spaced apart from one another in the first sub-portion;
an integrated circuit, arranged in the second sub-portion; and
a plurality of connecting portions, arranged on the substrate, and electrically connecting the antenna units with the integrated circuit.

2. The antenna assembly according to claim 1, wherein the substrate further comprises a bending portion connecting the first sub-portion with the second sub-portion, and the first sub-portion, the second sub-portion and the bending portion are integrally arranged; and
an end of the connecting portion is connected to the antenna units, and another end of the connecting portion extends to the integrated circuit through the bending portion to electrically connect the antenna unit with the integrated circuit.

3. The antenna assembly according to claim 1, wherein the first sub-portion and the second sub-portion are separately arranged, and the connecting portion comprises a first sub-segment arranged in the first sub-portion and electrically connected to the antenna unit and a second sub-segment arranged in the second sub-portion and electrically connected to the integrated circuit; and
the first sub-segment and the second sub-segment are bound and connected with each other, or the first sub-segment and the second sub-segment are electrically connected with each other through a joint.

4. The antenna assembly according to claim 1, further comprising at least one conductive isolation portion, arranged in the first sub-portion and located between two adjacent antenna units.

5. The antenna assembly according to claim 4, further comprising a plurality of conductive isolation portions, all of the conductive isolation portions are arranged on a surface of the first sub-portion, or
all of the conductive isolation portions are arranged in the first sub-portion, or
a part of the conductive isolation portions are arranged on a surface of the first sub-portion, and a part of the conductive isolation portion are arranged in the first sub-portion.

6. The antenna assembly according to claim 4, wherein the conductive isolation portion comprises a first isolation portion arranged on the surface of the first sub-portion and a second isolation portion arranged in the first sub-portion, and the first isolation portion and the second isolation portion are interconnected.

7. The antenna assembly according to claim 6, wherein the conductive isolation portion comprises a plurality of first isolation portions arranged on two surfaces of the first sub-portion opposite to each other, respectively, and the second isolation portion is connected to the plurality of first isolation portions located on the two surfaces of the first sub-portion opposite to each other.

8. A housing of a mobile terminal, wherein the mobile terminal comprises an antenna assembly, the antenna assembly comprises a plurality of antenna units, and the housing comprises:
a frame, surrounding and forming a hollow space, and comprising a sub-segment portion,
the sub-segment portion comprises an inner surface facing the hollow space and an outer surface away from the hollow space, at least one of the inner surface or the outer surface is recessed to form a first groove, and the first groove extends in an extending direction of the sub-segment portion and is configured to accommodate the plurality of antenna units.

9. The housing according to claim 8, wherein a first bottom wall of the first groove is recessed to form two or more concave cavities, and the concave cavities are configured to correspond to the antenna units, respectively;
the concave cavities and the antenna units are arranged in one-on-one correspondence.

10. The housing according to claim 8, wherein the sub-segment portion comprises a passage penetrating through the inner surface and the outer surface, and the passage communicates with the first groove.

11. The housing according to claim 8, wherein the first groove further comprises a first side wall connected to a peripheral side of a first bottom wall of the first groove, and the passage communicates with the first side wall or the first bottom wall;
or the sub-segment portion further comprises a side surface connecting the inner surface with the outer surface, and the passage is formed by recessing the side surface.

12. The housing according to claim 8, wherein the first groove is located on the outer surface, the housing further comprises a second groove formed by recessing the inner surface, and the second groove is configured to accommodate an integrated circuit of the antenna assembly.

13. A mobile terminal, comprising the antenna assembly according to claim 1 and a housing,
wherein the housing comprises:
a frame, surrounding and forming a hollow space, and comprising a sub-segment portion,
the sub-segment portion comprises an inner surface facing the hollow space and an outer surface away from the hollow space, at least one of the inner surface or the outer surface is recessed to form a first groove, and the first groove extends in an extending direction of the sub-segment portion and is configured to accommodate the plurality of antenna units; and
the first sub-portion is located in the first groove.

14. The mobile terminal according to claim 13, wherein the first groove is provided on the outer surface, and the second sub-portion is provided on the inner surface; the housing further comprises a second groove formed by recessing the inner surface, and the second sub-portion is located in the second groove.

15. The mobile terminal according to claim 14, wherein the first groove comprises a first bottom wall, and the antenna units are arranged on a side of the first sub-portion away from the first bottom wall;
the second groove comprises a second bottom wall, and the integrated circuit is arranged on a side of the second sub-portion away from the second bottom wall.

16. The mobile terminal according to claim 14, wherein the sub-segment portion comprises a passage penetrating through the inner surface and the outer surface, the passage communicates with the first groove, and the connecting portion is electrically connected to the antenna units and the integrated circuit through the passage.

17. The mobile terminal according to claim 14, wherein the sub-segment portion further comprises a first side surface and a second side surface connecting the inner surface with the outer surface and arranged opposite to each other, the passage is formed by recessing the first side surface, and a top face of the connecting portion away from the second side surface is coplanar with the first side surface, or a top face of the connecting portion away from the second side surface is located on a side of the first side surface facing the second side surface.

18. The mobile terminal according to claim 17, wherein the antenna assembly further comprises a connector, the connector is electrically connected to the integrated circuit, and each of the connector and the integrated circuit is arranged in the second sub-portion the plurality of antenna units are spaced apart from one another in the extending direction of the sub-segment portion; and the integrated circuit and the connector are spaced apart from each other in the extending direction of the sub-segment portion.

19. The mobile terminal according to claim 13, wherein the housing further comprises a decorative cover, arranged to cover the first groove;
or the decorative cover is arranged to cover the second groove;
or the decorative cover is arranged to cover the first groove and the second groove.

20. The mobile terminal according to claim 13, wherein two or more concave cavities are formed by recessing a first bottom wall of the first groove, and projections of the antenna units in a thickness direction of the sub-segment portion at least partially overlap with projections of the concave cavities in the thickness direction.
